(19) United States
(12) Patent Application Publication
(10) Pub. No.: US 2022/0155217 A1
(43) Pub. Date: May 19, 2022

(54) Improved Spark Stand for Optical Emission Spectrometry

(71) Applicant: Thermo Fisher Scientific (Ecublens) SARL, Ecublens (CH)

(72) Inventor: Patrick Lancuba, Ecublens (CH)

(21) Appl. No.: 17/442,885

(22) PCT Filed: Mar. 17, 2020
(86) PCT No.: PCT/EP2020/057232

§ 371 Date: Sep. 24, 2021

(30) Foreign Application Priority Data
Mar. 29, 2019 (GB) 1904395.9

(51) Int. Cl. G01N 21/15; G01N 21/67

(52) U.S. Cl. CPC G01N 21/15; G01N 2021/151; G01N 21/67

(57) ABSTRACT

A spark stand for an optical emission spectrometer, comprising: a spark chamber; a gas inlet for flowing gas into the spark chamber; a gas outlet for carrying gas from the spark chamber; wherein one or more internal surfaces of the spark chamber, gas inlet and/or gas outlet comprise an anti-adhesion material. The anti-adhesion material can enable reduced adhesion of ablated material, such as metallic dusts for example, onto the surfaces within the spark stand.

### CROSS-REFERENCE TO RELATED APPLICATIONS

This application is a National Stage application filed under 35 USC § 371 of International Patent Application No. PCT/EP2020/057232, filed on Mar. 17, 2020. PCT Application No, PCT/EP2020/057232, claims priority to GB Patent Application No. 1904395.9, filed Mar. 29, 2019, both of which are incorporated by reference herein in their entirety.

### TECHNICAL FIELD OF THE DISCLOSURE

This invention relates to the field of spark optical emission spectrometry. In particular, the invention is concerned with an improved spark stand for an optical emission spectrometer, an optical emission spectrometer comprising the same and a method of optical emission spectrometry.

### BACKGROUND OF THE INVENTION

Spark optical emission spectrometry is a well-known technique used to analyse solid samples. Optical emission spectrometry may be conducted with either a spark or arc for example. For convenience, as used herein, the term spark optical emission spectrometry means any optical emission spectrometry employing an electrical discharge to excite the sample such as a spark or arc for example, and the term spark chamber means a chamber for conducting any electrical discharge. A solid sample is typically mounted onto the table of a spark stand. The spark stand further comprises a spark chamber, within which is an electrode oriented to present a tapered end towards the sample surface. The table of the spark stand has an aperture in the spark chamber wall over which the sample is mounted, usually with an air-tight seal. The electrode is surrounded by an insulator except for its tapered end. A sequence of electrical discharges is initiated between the electrode and the sample, in which the sample acts as a counter-electrode. The insulator promotes discharge to the sample rather than the chamber wall. Sample material local to the discharges is vaporised and a proportion of the vaporised atomic material is raised to excited states. On relaxing, the atomic material emits photons, the energies of which are characteristic of the elements in the material. Spectroscopic analysis of the emitted photons enables the composition of the sample material to be deduced. A proportion of the light emission caused by the discharges is therefore transmitted from the spark chamber to the analyser for spectroscopic analysis. The spectroscopic analysis is conducted using an optical analyser which usually utilises a dispersive means such as a grating to disperse light spatially according to its wavelength. A detector, such as an array detector for example, is used to measure the quantity of light as a function of the degree of dispersion.

To obtain information about a wide range of elements within samples, the instrument must be capable of transmitting photons below 190 nm from the spark stand to the detector, as some elements emit photons in the ultraviolet (UV) wavelength range when relaxing to a lower energy state. To avoid absorption of these UV photons by air and to avoid wavelength shifts associated with changes in the refractive index of gases (which changes with the pressure of the gas and the gas composition), the sample material is excited in the presence of an inert gas, typically argon, which is fed into the spark chamber at least during the time when the sequence of spark discharges is initiated.

The electrical discharges cause material to be ablated from the sample surface and some of this material is not in atomised form. Some much larger aggregates or particles of material are ablated, i.e. removed, from the sample surface, which are useless for the spectroscopic process and are herein referred to as debris or dust. This ablated matter, along with the vaporised atomic material is liberated from the sample surface at each electrical discharge. To prevent cross contamination or so-called memory effects, preferably all the ablated material from one sample should be removed from the spark chamber before analysis of the next sample to eliminate any re-deposition of material from a preceding sample onto the next sample and to prevent any such material from being present in the path of the electrical discharges. The flowing argon gas, which surrounds the sample and the discharge path, is utilised to sweep ablated materials including metallic debris from the spark chamber in a continuous or semi-continuous process. The ablated material is typically carried away from the chamber in the flow of argon gas to a filter downstream.

A spark chamber having improved debris clearance is disclosed in WO 2012/028484 (Thermo Fisher Scientific). However, the debris is not completely removed and, over time, ablated sample material deposits and builds-up on the surfaces within the spark chamber and also along gas conduits. This leads to deterioration of the analytical performance of the spectrometer and when this occurs the spectrometer has to be shut down whilst the spark chamber is cleaned, which increases the costs of maintenance and the amount of instrument downtime.

In view of the above problems, the present invention has been made.

### SUMMARY OF THE DISCLOSURE

According to an aspect of the present invention there is provided a spark stand for an optical emission spectrometer, comprising:

a spark chamber;

a gas inlet for flowing gas into the spark chamber;

a gas outlet for carrying gas from the spark chamber;

wherein one or more internal surfaces of the spark chamber and/or gas inlet and/or gas outlet comprise an anti-adhesion material.

According to another aspect of the present invention there is provided an optical emission spectrometer comprising the spark stand. The optical emission spectrometer generally further comprises an optical analyser for analysing and detecting light from the spark chamber according to its wavelengths. For example, the optical emission spectrometer may comprise a spectrograph for separating the light by its wavelengths and detecting the separated light. The light is emitted by excited sample material in the spark chamber. In this way, an optical spectrum of the emitted light can be obtained that enables the composition of the sample material to be deduced. The spark stand and the optical emission spectrometer can be used for performing optical emission spectrometry.

According to a further aspect of the present invention there is provided a method of optical emission spectrometry, comprising: providing a spark stand having a spark chamber, a gas inlet for flowing gas into the spark chamber and a gas outlet for carrying gas from the spark chamber; and providing an anti-adhesion material at one or more internal surfaces of the spark chamber and/or gas inlet and/or gas outlet.

The method of the present invention may comprise other, well known steps of optical emission spectrometry, such as any of the following: providing a solid sample for analysis, typically which is mounted such that it presents a surface of the sample to the end of an electrode in the spark chamber and/or typically such that it lies over an aperture in the spark chamber wall facing the end of the electrode, usually with an air-tight seal; causing one or more, typically a sequence of, electrical discharges between the electrode and the sample, in which the sample acts as a counter electrode; vaporising material from the sample and exciting at least a proportion of the vaporised material whereby the excited material emits photons, the energies of which are characteristic of the elements in the material; and performing spectroscopic analysis of the emitted photons to thereby enable the composition of the sample material to be deduced; wherein a gas, preferably an inert gas, e.g. argon, is fed into the chamber via the gas inlet during the analysis.

The present invention can enable reduced adhesion of ablated material, such as metallic dusts for example, onto surfaces within the spark stand of an optical emission spectrometer. This is achieved by modifying the properties of one or more surfaces within the spark stand compared to conventional internal surfaces of a spark stand, which are generally metallic. The surface modification generally comprises providing an anti-adhesion material at the internal surfaces. The internal surface is contacted by the gas flow. Generally, one or more internal surfaces of the spark chamber and/or gas inlet and/or gas outlet comprise an anti-adhesion material. In some embodiments, internal surfaces of the spark chamber, gas inlet and gas outlet each comprise an anti-adhesion material. The anti-adhesion material preferably has anti-adhesion properties towards metallic particles, such as metallic dust particles. This reduces the tendency of such particles, which are ablated from a sample when a spark is applied during optical emission analysis, to stick to internal surfaces of the spark stand. The anti-adhesion material preferably reduces the adhesion of particles compared to conventional, metallic surfaces of a spark stand. The anti-adhesion material is generally non-metallic. The surface modification can be achieved in numerous ways, including providing one or more functional coatings on the surfaces and/or modifications or selection of the chemical composition of the surfaces or the substrate that provides the surface. The invention results in reduced metallic dust accumulation; stabilised analytical performance of the spectrometer over long operation periods and decreased costs associated with preventive maintenance, such as cleaning of the spark stand. The ease and speed of cleaning may be improved by the presence of the anti-adhesion material on the surfaces.

The anti-adhesion material is typically a non-metallic material. The anti-adhesion material is typically a material of low friction coefficient, e.g. having a static coefficient of friction and a dynamic coefficient of friction of 0.5 or less, or 0.4 or less, or 0.3 or less. Non-stick coatings have been used for example in the food industry but not in applications or under conditions comparable to those found in a spark chamber of an optical emission spectrometer. Examples of non-stick coatings for the food industry comprising fluoropolymers are disclosed in WO 01/49424 A2.

The anti-adhesion material can comprise a polymeric material (polymer). The polymeric material preferably can comprise a fluorinated polymeric material (i.e. a fluoropolymer). The fluorinated polymeric material can comprise a perfluorinated polymeric material (i.e. a perfluoropolymer). A perfluorinated polymer is an organofluorine polymer that contains only C—F and C—C bonds (i.e. not C—H bonds), optionally with one or more C-heteroatom bonds (from one or more functional groups). Common functional groups in perfluorinated polymers include OH, CO₂H, Cl, Br, O, and SO₃H. Preferred anti-adhesion materials include polymers such as fluorinated (especially perfluorinated) polyalkylenes, e.g. polytetrafluoroethylene (PTFE) and fluorinated propylene ethylene (FPE); fluorinated (especially perfluorinated) functional alkane polymers, e.g. fluorinated alkoxyalkanes, such as perfluoroalkoxy alkane (PFA), which are copolymers of tetrafluoroethylene and perfluoroethers; and fluorinated parylenes, such as parylene F-AF4 and parylene F-VT4. The anti-adhesion material can be a mixture of any two or more (different) types of polymers, such as any two or more of the aforementioned types of polymers.

In some embodiments, the anti-adhesion material can comprise a ceramic material, for example zirconium dioxide (ZrO₂) or boron aluminium magnesium alloys (BAM).

In some embodiments, the anti-adhesion material can be provided as a coating. The coating can generally be provided on the surface of the underlying substrate of the spark stand. The thickness of the coating is preferably 10 μm to 1 mm or 10 μm to 500 μm, or more preferably 10 μm to 200 μm, or 10 to 100 μm. However, the thickness may be less or more than this, e.g. 1 μm to 2 mm. The coating can be applied, i.e. to the surface or substrate, as an adhesive or by chemical vapour deposition (CVD) or any other suitable method. The CVD method can enable thin films of controlled thickness.

In some embodiments, the anti-adhesion material can be provided as one or more blocks of material. This can be realised by substituting part of the substrate of the spark stand, which is typically metal, that is surrounding the spark chamber and/or inlet and/or outlet with one or more blocks of the anti-adhesion material. In some embodiments, the anti-adhesion material forms the material of the spark stand, i.e. the substrate material of the spark stand.

The spark chamber generally comprises a gas inlet, typically located in a wall of the spark chamber on a first side of the spark chamber, for supplying a gas, for example an inert gas such as argon, into the spark chamber. The gas inlet typically comprises a conduit (herein referred to as the gas inlet conduit) through which a gas flows into the spark chamber. In some embodiments, one or more internal surfaces of the gas inlet conduit comprises the anti-adhesion material. The spark chamber also generally comprises a gas outlet, typically located in a wall of the spark chamber on a second side of the spark chamber, typically opposite to the first (inlet) side, and arranged to convey the gas from the spark chamber. The gas outlet typically comprises a conduit (herein referred to as the gas outlet conduit). The gas outlet conduit typically carries the gas from the spark chamber, for example to an exhaust or vent. In some embodiments, one or more internal surfaces of the gas outlet conduit comprises the anti-adhesion material. Thus the one or more internal surfaces of the gas inlet and/or gas outlet that comprise an anti-adhesion material may be one or more internal surfaces of the gas inlet conduit and/or gas outlet conduit.

The gas inlet generally comprises one or more orifices in the first side of the spark chamber to which is typically connected a conduit supplying gas. Preferably the gas inlet has a single orifice in the first side of the spark chamber to which is connected a conduit supplying gas. The gas outlet generally comprises one or more orifices, preferably a single orifice, in the second side of the spark chamber to which is typically connected an outlet conduit for conveying gas from the chamber. The orifices for the gas inlet and gas outlet, and the inlet and outlet conduits, may be any suitable cross sectional shape. For example, the one or more orifices or conduits may be circular, ovoid, square, or rectangular in shape. The one or more orifices can have a height substantially equal to the height of the spark chamber at the inlet and/or outlet respectively.

An elongated electrode having an electrode axis generally along the direction of elongation is generally located within the spark chamber. In use, there is generally a gas flow through the spark chamber between the gas inlet and the gas outlet. Preferably, the wall of the spark chamber, i.e. the radial wall (radially facing the electrode), is curved thereby defining an internal volume of the spark chamber with a curved outer shape, preferably cylindrical, i.e. the wall of the spark chamber defines a cylindrical shape. The surface of such wall may comprise an anti-adhesion material. Preferably the spark chamber is substantially cylindrical and the electrode is located approximately on the axis of the cylinder. Preferably the gas inlet and the gas outlet are located on the curved internal wall of the cylinder and are on opposing sides of the cylinder, more preferably on substantially diametrically opposing sides. Preferably the gas inlet and the gas outlet are diametrically opposed to each other on the chamber wall.

The elongated electrode may be of any cross sectional shape (i.e. in cross section transverse to the electrode axis), but is preferably cylindrical in shape with a tapered conical end which extends within the spark chamber towards a sample position. Preferably, the elongated electrode is a pin-shaped electrode. The elongated electrode has an axis, herein referred to as the electrode axis, the axis extending generally along the direction of elongation and the electrode is oriented within the spark chamber so that the axis is directed towards the sample position. The electrode axis is preferably located substantially radially centrally in the spark chamber. In a preferred embodiment, the electrode axis also defines an axial direction of the spark chamber, with the gas flowing in a generally radial direction from the inlet on the first side of the spark chamber to the outlet on the second side of the spark chamber. Preferably the spark chamber internal shape and components are such that turbulence of the gas flow is substantially eliminated, for instance as described in WO 2012/028484, the contents of which is hereby incorporated in its entirety. The spark stand typically comprises a table that covers the spark chamber, wherein the table has an aperture that is positioned over the spark chamber. The table may receive a sample such that the sample covers the aperture and thereby presents a surface to the electrode, which surface can be analysed.

### BRIEF DESCRIPTIONS OF THE DRAWINGS

FIG. 1 shows schematically a cross-sectional view of a spark stand.

FIG. 2 shows the chemical structures of fluorinated polymers used as surface coatings in the Examples.

### DETAILED DESCRIPTION OF PREFERRED EMBODIMENTS

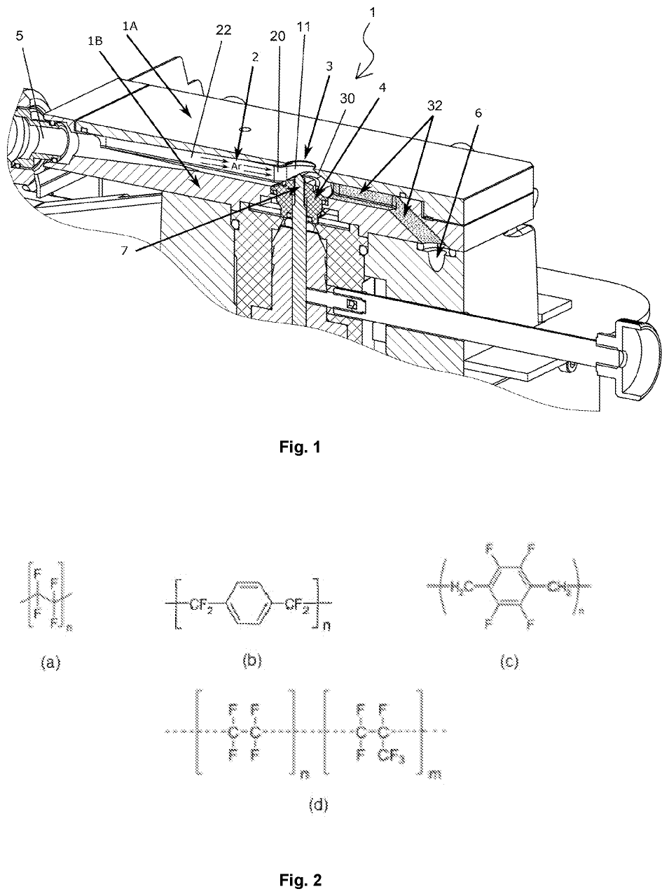

FIG. 1 shows a schematic cross-sectional view of a spark stand 1 that forms part of an optical emission spectrometer. The spark stand comprises a spark chamber 11 of generally cylindrical geometry, i.e. having a cylindrical chamber wall. The spark chamber houses a cylindrical electrode 7 having a pin-shaped end, which is surrounded by an insulator 4 to prevent discharges to the chamber wall. Insulator 4 is rotationally symmetric about the electrode 7. The view of the spark stand 1 has been cut away from other parts of the optical emission spectrometer. For example, a spectrograph is not shown that receives light emission from the spark chamber through an optical conduit 5.

The spark stand comprises an upper table 1A having an aperture 3 positioned over the spark chamber 11. In use, a metallic sample (not shown) is mounted onto the table so that a face of the sample covers aperture 3. A spark is ignited between the electrode 7 and the surface of the sample that faces the electrode. This generates a plasma which ablates and vaporises matter from the sample, followed by atomisation, excitation and light emission. The light is analysed by the spectrograph (not shown) to determine information about the composition of the sample.

The spark ignition takes place under an argon (Ar) atmosphere, which is provided by a flow of argon into the spark chamber 11 through gas inlet orifice 20 which is connected to gas inlet conduit 22. The gas inlet conduit 22 is fed with argon gas from an argon source upstream. The gas flows in the direction indicated by arrows 2. For example, argon gas of purity better than 99.997% may be fed into the spark chamber via the gas inlet at a rate of 5 slpm (standard litres per minute) during sample analysis. Ablated matter is carried from the spark chamber by the gas flow through a gas outlet orifice 30 and gas outlet conduit 32 to an exhaust pipe 6. The gas inlet and outlet orifices 20 and 30 lie on opposing sides of the spark chamber 11. The gas inlet and outlet conduits 22 and 32 are provided by channels formed in one or both of two modular metallic components that are stacked together: a lower table 1B and the upper table 1A. The lower table 1B is generally fixed in place and the upper table 1A is removable. The upper table 1A can thus be removed to allow cleaning of the spark chamber and gas inlet and outlet conduits. The lower, fixed table 1B is fixed in place by screws (not shown), which can be removed, if required, to allow removal of the table 1B and cleaning of the exhaust pipe. Over multiple cycles of analysis, i.e. many sparks, part of the ablated matter adheres on the insulator 4 surrounding the electrode 7 and accumulates on the surfaces of the spark chamber wall and conduit 32, causing performance degradation and requiring regular maintenance by cleaning of the insulator 4, spark chamber 11 and the fixed (1B) and movable (1A) tables.

In accordance with the invention, one or more of the internal surfaces of the spark chamber 11 and/or gas inlet 22 and/or gas outlet 32 comprise an anti-adhesion material. In an embodiment, one or more of the internal surfaces of at least the spark chamber 11 and/or gas outlet conduit 32 comprise the anti-adhesion material. Preferably, at least internal surfaces of the spark chamber 11 and gas outlet conduit 32 comprise the anti-adhesion material. The internal surface of the gas inlet is less prone to accumulation of ablated material as the direction of gas flow sweeps ablated material away from the inlet towards the outlet. However, in some embodiments, an internal surface of the gas inlet 22 can also comprise the anti-adhesion material, such as a portion of the conduit adjoining the inlet 20.

In some embodiments, the anti-adhesion material is provided as a coating, i.e. a coating having the function of reducing the adhesion of particles compared to the uncoated surface. The coating can be provided as a polymer coating, especially a fluorinated polymer coating. The coating can be provided as a powder coating (high performance powder coating) and/or a dry film coating.

Preferred properties of the anti-adhesion material include any one or more of: i) low static and dynamic friction coefficients, preferably each 0.5 or less, allowing for minimum ablated dust accumulation by mechanical forces; ii) strong abrasion resistance, for example having a wear rate of <0.001 mm3/(N*m); iii) high vacuum ultraviolet (VUV) resistance, which is important in the vicinity of the spark/arc light source, for example a) high chemical bond dissociation energy (Carbon-Fluorine is ˜546 kJ/mol) and b) low photon penetration depth (<200 nm); iv) high dielectric strength, for example at least 50 MV/m, which is important to maintain spark/arc stability in the vicinity of the electrode; and v) high resistance to chemical solvents, which are used for cleaning during maintenance procedures. The surface roughness of the anti-adhesion material may depend on the surface of the substrate. The surface roughness of the anti-adhesion material can be 10 μm or less. Another desirable property of the anti-adhesion material is a Rockwell hardness of at least R50, e.g. >R54 (PTFE).

The coating can be applied by methods such as chemical vapour deposition (CVD), which selectively and controllably grows a thin, conformal film onto the selected surfaces. Preferred anti-adhesion materials include polymers such as fluorinated polymers and perfluorinated polymers. Examples include: fluorinated polyalkylenes, e.g. polytetrafluoroethylene (PTFE) and fluorinated propylene ethylene (FPE) co-polymer; fluorinated functional alkane polymers, e.g. fluorinated alkoxyalkanes polymers, such as perfluoroalkoxy alkane (PFA) polymer, which are copolymers of tetrafluoroethylene (C₂F₄) and perfluoroethers; and fluorinated arylene polymers, e.g. parylenes, such as parylene F-AF4 and parylene F-VT4. The anti-adhesion material can be a mixture of any two or more types of polymers.

In other embodiments, the composition of the fixed (1B) and movable (1A) tables, or a part of them, can be modified or substituted to be inherently anti-adherent to the ablated metallic dust. Thus, the spark table substrates present internal surfaces in the spark chamber and gas inlet and outlet that are anti-adherent to the dust. As the regions surrounding the plasma operate at very high temperatures (thousands of Kelvin), it may be possible to replace a part of the conventional metallic substrate of the tables 1A and 1B surrounding the chamber, inlet and/or outlet with, for example, the anti-adherent material such as fluorinated polymers. The anti-adherent material, such as fluorinated polymers, may be provided as blocks. This may be achieved, for example, by mechanically substituting part of the metal substrate of the tables surrounding the chamber, inlet and/or outlet with blocks of the anti-adherent material.

In other embodiments, the whole composition of the fixed table (1B) and/or movable table (1A) of the spark stand could be made of the anti-adhesion material, i.e. instead of the conventional metal material that is used, the table could be made of, for example, an anti-adhesion polymer or ceramic material. This may be achieved, for example, by engineering the tables with polymers or ceramic materials, such as zirconium oxide (ZrO₂) or boron aluminium magnesium alloys (BAM).

### SPECIFIC EXAMPLES

Tests were performed in which coatings of various compositions were applied onto internal surfaces of a spark stand of the type shown in FIG. 1, where metallic dusts ablated from the sample are known to be deposited. The spark stand was part of an ARL™ iSpark™ optical emission spectrometer from Thermo Fisher Scientific™. Each of the coatings was applied to the outlet conduit 32 between the spark chamber 11 and the exhaust pipe 6 (shaded region shown in FIG. 1). Fluorinated polymers were tested due to their low friction coefficient (excellent non-stick properties) and their high resistance to a) VUV light, b) abrasion and c) chemical solvents.

Four types of fluorinated polymers were tested:

### 1) Polytetrafluoroethylene (PTFE),

### 2) Parylene F-AF4,

### 3) Parylene F-VT4,

### 4) Fluorinated Propylethylene (FPE).

The chemical structures are shown in FIG. 2: (a) PTFE; (b) Parylene F-AF4; (c) Parylene F-VT4; and (d) FPE.

The tests were conducted by analysing aluminium (Al) samples, except where mentioned below where iron (Fe) and copper (Cu) were also tested. Each test comprised 2500 runs, where a run corresponded to an attack onto a single sample location. Each run comprised several thousand sparks. The spark frequency was 300 Hz and each run had a duration of 28.2 seconds.

The effectiveness of the coatings was evaluated by 1) visually inspecting the spark stand conditions; 2) measuring the weight of the exhaust dusts that adhered on the surfaces; and 3) evaluating the difficulty and time required to clean the coated areas.

Each test comprised a control test performed without coated surfaces as a reference, followed by a test with the coated surfaces.

Results

### (a) Polytetrafluoroethylene (PTFE)

An adhesive of Polytetrafluoroethylene (PTFE) was applied to the outlet conduit 32 (shaded region) as shown in FIG. 1. The layer consisted of a coated adhesive and had a thickness of 1 mm. After testing, the visual inspection of the coated spark tables (1A and 1B) showed a marked reduction of both the thickness and the area covered by exhaust dusts. The weight of the exhaust dusts was reduced by 84% compared to the test made without a coating. A few seconds were required to clean the coating with isopropyl alcohol and paper, leaving essentially no dust remnants on the surface.

### (b) Parylene F-AF4

A coating of Parylene F-AF4 with a thickness of 10 μm was applied to the surface by a chemical vapour deposition (CVD) process. After testing, the visual inspection of the coated spark tables showed adherence of exhaust dusts but the adhered dust weight was reduced by 30%. A few seconds were required to clean the coating with isopropyl alcohol and paper, leaving essentially no dust remnants on the surface.

### (c) Parylene F-VT4

A coating of Parylene F-VT4 with a thickness of 50 μm was applied by chemical vapour deposition (CVD) process. Parylene After testing, the visual inspection of the coated tables showed a clear reduction of both the thickness and area covered by exhaust dusts. The adhered dust weight was reduced by 77%. A few seconds were required to clean the coating with isopropyl alcohol and paper, leaving essentially no dust remnants on the surface.

A different coating of Parylene F-VT4 with a thickness of 20-25 μm showed a reduction of the adhered dust weight by 64%. Parylene F-VT4 is chemically inert, has a coefficient of friction of 0.39/0.35 (static/dynamic) and a Rockwell hardness of R80.

### (d) Fluorinated Propyl Ethylene (FPE)

A coating of FPE with a thickness of 50 μm was applied by chemical vapour deposition (CVD) process. However, the adhered dust weight was reduced by 53%. A few seconds were required to clean the coating with isopropyl alcohol and paper, leaving essentially no dust remnants on the surface.

A different coating of FPE with a thickness of 80-90 μm showed a reduction of the adhered dust weight by 56%. The same coating of FPE with a thickness of 80-90 μm was also tested with iron (Fe) and copper (Cu) samples. The test with Fe showed a reduction of the adhered dust weight by 64% and the test with Cu showed a reduction of the adhered dust weight by 30%. FPE is chemically inert, has a coefficient of friction of 0.25/0.20 (static/dynamic) and a Rockwell hardness of R54.

The results demonstrate that the coatings of anti-adhesion materials enable longer time intervals between cleaning operations (thus improving maintainability of the instrument), fast cleaning times and improved plasma conditions as the analytical conditions are less affected by adhered exhaust dusts.

It will be appreciated that variations to the foregoing embodiments of the invention can be made while still falling within the scope of the invention.

The use of any and all examples, or exemplary language (“for instance”, “such as”, “for example” and like language) provided herein, is intended merely to better illustrate the invention and does not indicate a limitation on the scope of the invention unless otherwise claimed. No language in the specification should be construed as indicating any non-claimed element as essential to the practice of the invention.

As used herein, including in the claims, unless the context indicates otherwise, singular forms of the terms herein are to be construed as including the plural form and vice versa. For instance, unless the context indicates otherwise, a singular reference herein including in the claims, such as “a” or “an” means “one or more”.

Throughout the description and claims of this specification, the words “comprise”, “including”, “having” and “contain” and variations of the words, for example “comprising” and “comprises” etc, mean “including but not limited to”, and are not intended to (and do not) exclude other components.

1. A spark stand for an optical emission spectrometer, comprising:
a table having an aperture for receiving a solid sample to be analysed such that the solid sample covers the aperture;
a spark chamber having an electrode therein; wherein the aperture is positioned over the spark chamber;
a gas inlet for flowing gas into the spark chamber;
a gas outlet for carrying gas from the spark chamber;
wherein one or more internal surfaces of the spark chamber, the gas inlet, or the gas outlet comprise an anti-adhesion material.

2. A spark stand according to claim 1, wherein the anti-adhesion material has dynamic and static coefficients of friction of 0.5 or less, or 0.4 or less, or 0.3 or less.

3. A spark stand according to claim 1, wherein the anti-adhesion material comprises a polymeric material.

4. A spark stand according to claim 1, wherein the polymeric material comprises a fluorinated polymeric material.

5. A spark stand according to claim 4, wherein the fluorinated polymeric material comprises at least one of: a fluorinated polyalkylene, a fluorinated functional alkane polymer, or a fluorinated parylene polymer.

6. A spark stand according to claim 5, wherein the fluorinated polymeric material comprises at least one of: polytetrafluoroethylene (PTFE), fluorinated propylene ethylene (FPE), perfluoroalkoxy alkane (PFA), parylene F-AF4, or parylene F-VT4.

7. A spark stand according to claim 4, wherein the fluorinated polymeric material comprises a perfluorinated polymeric material.

8. A spark stand according to claim 3, wherein the anti-adhesion material comprises a mixture of two or more different polymeric materials.

9. A spark stand according to claim 1, wherein the anti-adhesion material comprises a ceramic material.

10. A spark stand according to claim 1, wherein the anti-adhesion material is provided as a coating.

11. A spark stand according to claim 1, wherein the anti-adhesion material is provided as a block of material.

12. A spark stand according to claim 1, wherein the anti-adhesion material forms a substrate material of the spark stand.

13. An optical emission spectrometer comprising:
a spark stand having:
a table having an aperture for receiving a solid sample to be analyzed such that the solid sample covers the aperture;
a spark chamber having an electrode therein, wherein the aperture is positioned over the spark chamber;
a gas inlet for flowing gas into the spark chamber; and
a gas outlet for carrying gas from the spark chamber, wherein one or more internal surfaces of the spark chamber, the gas inlet, or the gas outlet comprise an anti-adhesion material.

14. A method of optical emission spectrometry, comprising:
providing a spark stand having a spark chamber, a gas inlet for flowing gas into the spark chamber and a gas outlet for carrying gas from the spark chamber; and
providing an anti-adhesion material at one or more internal surfaces of the spark chamber and/or gas inlet and/or gas outlet.
